(19) United States
(12) Patent Application Publication
(10) Pub. No.: US 2026/0017567 A1
(43) Pub. Date: Jan. 15, 2026

(54) DATA SELECTION DEVICE AND DATA SELECTION PROGRAM

(71) Applicant: TOYOTA JIDOSHA KABUSHIKI KAISHA, Toyota-shi Aichi-ken (JP)

(72) Inventor: Lukasz Kamil Majewski, Chiba-shi Chiba-ken (JP)

(73) Assignee: TOYOTA JIDOSHA KABUSHIKI KAISHA, Toyota-shi Aichi-ken (JP)

(21) Appl. No.: 19/260,851

(22) Filed: Jul. 7, 2025

(30) Foreign Application Priority Data
Jul. 10, 2024 (JP) 2024-111169

(51) Int. Cl. G06N 20/00

(52) U.S. Cl. CPC G06N 20/00

(57) ABSTRACT

A data selection device which selects data used for training a machine learning model from a dataset including a plurality of target data, includes a processor. The processor is configured to: calculate, from one target data in the dataset, a target data feature of the target data using a feature calculation model; and determine whether to select the target data as data used for training the machine learning model, based on similarity between an individual feature relating to the target data including the target data feature, and an individual feature of other target data in the dataset or an individual feature of data already selected for training the machine learning model.

### CROSS-REFERENCE TO RELATED APPLICATIONS

This application claims priority to Japanese Patent Application No. 2024-111169 filed Jul. 10, 2024, the entire contents of which are herein incorporated by reference.

### FIELD

The present disclosure relates to a data selection device and a data selection program.

### BACKGROUND

Various machine learning models have been known (JP2022-550094A, JP2023-085353A, JP2022-056611A). In particular, JP2022-550094A discloses that data to be used for training a machine learning model is selected based on a result obtained when the data is inputted into the machine learning model.

When training a machine learning model, it is possible to perform more appropriate training by using data having different properties. This is because, by performing training using a wide range of data having different properties, a machine learning model that can addresses different situations can be generated. On the other hand, when data of a similar property is used, the training effect is not improved, the training processing time is unnecessarily lengthened, and the man-hour of annotation is unnecessarily increased. However, in the method of JP2022-550094A, various data having different properties cannot necessarily be selected as data to be used for training a machine learning model.

### SUMMARY

In view of the above-described problems, an object of the present disclosure is to be able to select various types of data having different properties as training targets.

The gist of the present disclosure is as follows.
(1) A data selection device which selects data used for training a machine learning model from a dataset including a plurality of target data, comprising a processor,
   the processor is configured to:
   calculate, from one target data in the dataset, a target data feature of the target data using a feature calculation model; and
   determine whether to select the target data as data used for training the machine learning model, based on similarity between an individual feature relating to the target data including the target data feature, and an individual feature of other target data in the dataset or an individual feature of data already selected for training the machine learning model.
(2) The data selection device according to above (1), wherein
   the processor is configured to:
   acquire situation data relating to a situation when each target data was generated; and
   calculate an individual feature by combining the calculated target data feature with a feature of the acquired situation data, for each target data.
(3) The data selection device according to above (1) or (2), wherein the processor is configured to select one target data as data used for training the machine learning model when a similarity between an individual feature of data already selected for training the machine learning model and an individual feature of the target data is equal to or less than a predetermined value.
(4) The data selection device according to above (1) or (2), wherein the processor is configured to select one target data as data used for training the machine learning model when a similarity between an individual feature of data already used for training the machine learning model and an individual feature of the target data is equal to or less than a predetermined value.
(5) A non-transitory computer readable medium having recorded thereon a data selection program which selects the data used for training a machine learning model from a dataset including a plurality of target data, the data selection program causing a computer to execute a process comprising:
   calculating, from one target data in the dataset, a target data feature of the target data using a feature calculation model; and
   determining whether to select the target data as data used for training the machine learning model, based on similarity between an individual feature relating to the target data including the target data feature, and an individual feature of other target data in the dataset or an individual feature of data already selected as training of the machine learning model.

### BRIEF DESCRIPTION OF DRAWINGS

FIG. 1 is a diagram schematically illustrating a configuration of a vehicle that transmits image data for configuring a data set.

FIG. 2 is a configuration diagram schematically illustrating a data selection device according to one embodiment.

FIG. 3 is a diagram illustrating a state of combining a target data feature vector and a situation data feature vector.

FIG. 4 is a diagram schematically illustrating a vector space of individual feature vectors.

FIG. 5 is a flowchart illustrating a flow of a data selection process executed in the data selection device according to one embodiment.

### DESCRIPTION OF EMBODIMENTS

Hereinafter, embodiments will be described in detail with reference to the drawings. In the following description, the same reference numerals are given to the same constituent elements.

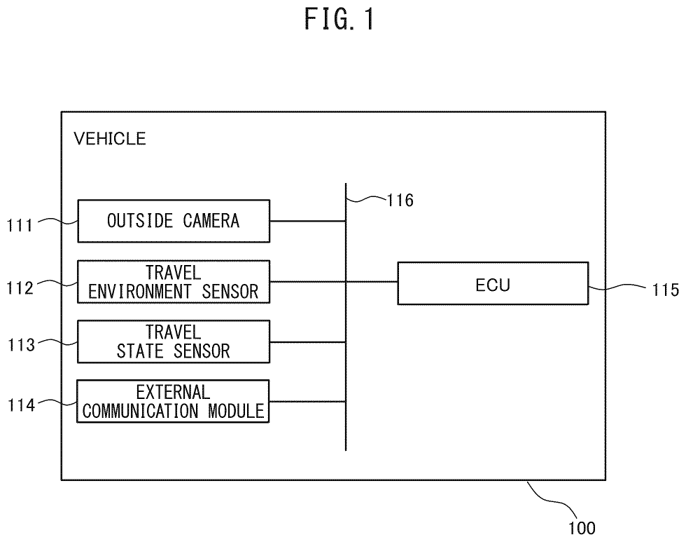

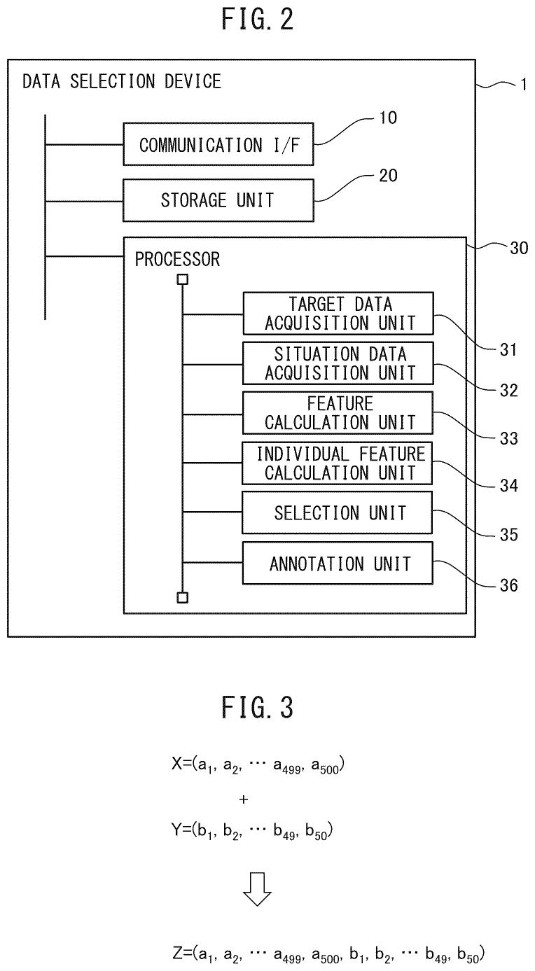

First, the data selection device 1 according to one embodiment will be described with reference to FIGS. 1 and 2. The data selection device 1 selects data to be used for training the machine learning model from a data set including a plurality of target data.

In describing the data selection device 1, first, a machine learning model and a data set will be described. In the present embodiment, when image data is input, the machine learning model outputs matters related to the image data. For example, when image data is input, the machine learning model outputs a prediction result regarding an object included in an image represented by the image data.

In particular, in the present embodiment, image data in front of a vehicle captured by the outside camera attached to the vehicle is input to the machine learning model. Then, the machine learning model outputs a prediction result such as a position and a type of an object (for example, a surrounding vehicle, a pedestrian, a road, a lane marking, a sign, an obstacle on a road, or the like) included in an image represented by the input image data. Note that the machine learning model may be any model as long as it is a model that outputs matters related to arbitrary data (not limited to image data) when the arbitrary data is input.

The data set includes image data transmitted from the plurality of vehicles 100. FIG. 1 is a diagram schematically illustrating a configuration of a vehicle 100 that transmits image data which configures a data set.

As illustrated in FIG. 1, the vehicle 100 includes an outside camera 111, a travel environment sensor 112, a travel state sensor 113, an external communication module 114, and an electronic control unit (ECU) 115. These are communicatively connected to each other via an in-vehicle network 116 compliant with standards such as CAN (Controller Area Network).

The outside camera 111 is a camera that captures an image of the front of the vehicle 100. The outside camera 111 captures an image of the front of the vehicle 100 at predetermined imaging cycles, and generates image data.

The travel environment sensor 112 is a sensor that detects a travel environment of the vehicle 100. The travel environment sensor 112 detects, for example, a travel environment such as a travel position of the vehicle 100, weather during traveling, and a travel time. Specifically, the travel environment sensor 112 includes, for example, a sensor (for example, a GNSS receiver) that measures the self-position of the vehicle 100, a rain sensor that determines whether or not the vehicle is in rain, and a time sensor that detects the present time.

The travel state sensor 113 is a sensor that detects a travel state of the vehicle 100. The travel state sensor 113 detects, for example, a travel state such as a speed and an acceleration of the vehicle 100, and a change speed of the yaw angle (yaw rate) at the time of turning of the vehicle 100. Specifically, the travel state sensor 113 includes, for example, a speed sensor that detects the speed of the vehicle 100, an acceleration sensor that detects the acceleration of the vehicle 100, and a yaw sensor that detects the yaw rate of the vehicle 100.

Note that the travel environment detected by the travel environment sensor 112 and the travel state detected by the travel state sensor 113 when certain image data is generated by the outside camera 111 are data related to the situation when the image data is generated. Therefore, in this specification, such data is referred to as situation data when image data is generated by the outside camera 111.

The external communication module 114 communicates with an out-of-vehicle device. The external communication module 114 is a device that wirelessly communicates with wireless base station in accordance with a predetermined mobile communication standard. The external communication module 114 transmits the image data generated by the outside camera 111 and the situation data when each image data is generated to the data selection device 1.

The ECU 115 controls transmission of data from the external communication module 114. The ECU 115 stores data (image data and situation data) detected by the outside camera 111, the travel environment sensor 112, and the travel state sensor 113. In addition, the ECU 115 transmits the stored data to the data selection device 1 via the external communication module 114 at any timing.

Next, the configuration of the data selection device 1 will be described with reference to FIG. 2. FIG. 2 is a configuration diagram schematically illustrating the data selection device 1 according to one embodiment.

As illustrated in FIG. 2, the data selection device 1 includes a communication interface 10, a storage unit 20, and a processor 30. Note that the communication interface 10, the storage unit 20, and the processor 30 may be separate circuits or may be configured as one integrated circuit.

The communication interface 10 is an interface circuit for connecting the data selection device 1 to an external device of the data selection device 1. The data selection device 1 transmits and receives data to and from an external device via the communication interface 10. The external device includes, for example, an external communication module 114 of any vehicle 100. Further, the external device includes a training device that causes a machine learning model to be trained. In addition, the external device may include an input device (e.g., keyboard, mouse, etc.) by the user and an output device (e.g., display, speaker, etc.) to the user. In the present embodiment, the communication interface 10 receives data (image data and situation data) stored in the ECU 115 from the ECU 115 of the vehicle 100 via the external communication module 114, and stores the data in the storage unit 20. Further, the communication interface 10 transmits the image data for training selected by the data selection device 1 and then annotated, to the training device.

The storage unit 20 is a non-transitory storage medium that stores data. The storage unit 20 includes, for example, at least one of a volatile semiconductor memory, a nonvolatile semiconductor memory, a hard disk drive (HDD), and a solid state drive (SSD). The storage unit 20 stores a computer program executed by the processor 30, in particular, a data selection program for executing a data selection process. In addition, the storage unit 20 stores image data for training selected by the processor 30 and annotated.

The storage unit 20 also stores data used in a computer program executed by the processor 30, such as data received from the vehicle 100 via the communication interface 10. In the present embodiment, the storage unit 20 stores a plurality of pieces of data (image data and situation data) received from the plurality of vehicles 100 as one data set. Thus, one data set includes a plurality of image data and situation data.

The processor 30 comprises one or more CPU (Central Processing Unit) and its peripheral circuitry. The processor 30 may further include other arithmetic circuits such as a logical arithmetic unit or a numerical value arithmetic unit. The processor 30 executes a computer program stored in the storage unit 20. In particular, in the present embodiment, the processor 30 executes the data selection program stored in the storage unit 20.

As illustrated in FIG. 2, the processor 30 includes a target data acquisition unit 31, a situation data acquisition unit 32, a feature calculation unit 33, an individual feature calculation unit 34, a selection unit 35, and an annotation unit 36. These units included in the processor 30 are, for example, functional modules realized by a computer program running on the processor 30. Alternatively, each unit of the processor 30 may be implemented in the data selection device 1 as an independent integrated circuit, microprocessor, or firmware.

The target data acquisition unit 31 acquires, from the storage unit 20, target data which can be selected as data used for training the machine learning model. In the present embodiment, since the image data is input to the machine learning model, the target data acquisition unit 31 acquires the image data which can be selected from the data sets stored in the storage unit 20.

The situation data acquisition unit 32 acquires, from the storage unit 20, situation data related to a situation when the target data acquired by the target data acquisition unit 31 is generated. The situation data acquisition unit 32 acquires situation data corresponding to the target data acquired by the target data acquisition unit 31 from one data set stored in the storage unit 20. In the present embodiment, as described above, the situation data includes data related to the travel environment and the travel state of the vehicle 100 when the image data is generated by the outside camera 111.

The feature calculation unit 33 calculates a target data feature of the target data from one target data in the data set using the feature calculation model. In the present embodiment, the feature calculation unit 33 calculates the target data feature of the image data by inputting one piece of image data to the feature calculation model. The target data feature is, for example, a feature vector (target data feature vector) representing a feature of the target data.

The feature calculation model for the target data is, for example, an encoder that outputs a target data feature vector when one piece of image data is input. The feature calculation model for the target data is, for example, a convolutional neural network (CNN) trained in advance to output a target data feature vector when one piece of image data is input. The feature calculation model for the target data is configured to output a similar feature vector as the image represented by the image data is a similar image. Therefore, the feature calculation model for the target data outputs, for example, a similar feature vector (a vector having a close distance between feature vectors) for the image data representing an image of the intersection of a city and an image data representing the image of another intersection of the city. On the other hand, the feature calculation model for the target data outputs different feature vectors (vectors having a far distance between feature vectors) for, for example, image data representing an image of intersection of a city and image data representing an image of a single rural road.

In addition, the feature calculation unit 33 may calculate a situation data feature of the situation data from one situation data in the data set by using the feature calculation model. In the present embodiment, the feature calculation unit 33 calculates a feature (situation data feature) for the situation data by inputting one situation data (data representing a travel environment and a travel state when one image data is generated) into the feature calculation model for the situation data. The situation data feature is, for example, a feature vector (situation data feature vector) representing a feature of the situation data.

The feature calculation model for the situation data is, for example, an encoder that outputs a situation data feature vector when one situation data is input. The feature calculation model for the situation data is, for example, a deep neural network (DNN) trained in advance so as to output the situation data feature vector when one situation data is input. The feature calculation model for the situation data is configured to output a similar feature vector as the situation represented by the situation data is a similar situation. Therefore, the feature calculation model for the situation data outputs a similar feature vector (a vector having a short distance between the feature vectors) for, for example, situation data when traveling the intersection of the city in a fine daytime and situation data when traveling another intersection of the city in a fine daytime. On the other hand, the feature calculation model for the situation data outputs different feature vectors (vectors having a long distance between feature vectors) for, for example, situation data when traveling an urban intersection in a fine daytime and situation data when traveling a single rural road in a rainy evening.

In the present embodiment, the feature calculation unit 33 uses a feature calculation model for the situation data in calculating the situation data feature from the situation data. However, the situation data feature may be substantially the same as the situation data, or may be a normalized value of a parameter included in the situation data. In this case, the feature calculation unit 33 uses, for example, the situation data as the situation data feature without using the feature calculation model.

The individual feature calculation unit 34 calculates an individual feature by combining the target data feature calculated by the feature calculation unit 33 for each target data and the feature of the situation data acquired by the situation data acquisition unit. In the present embodiment, the individual feature calculation unit 34 calculates an individual feature vector by combining the target data feature vector and the situation data feature vector.

FIG. 3 is a diagram illustrating a state of combining a target data feature vector and a situation data feature vector. In the example shown in FIG. 3, the target data feature vector X is a 500-dimensional vector, and the situation data feature vector Y is a 50-dimensional vector. The individual feature value calculation unit 34 calculates a 550-dimensional individual feature vector Z by combining the target data feature vector X and the situation data feature vector Y.

In the present embodiment, the individual feature is calculated by combining the target data feature and the situation data feature. However, the individual feature may be a feature independent of the situation data feature. In this case, the individual feature is, for example, the same feature as the target data feature. In any case, the individual feature for the target data includes the target data feature.

The selection unit 35 determines whether or not to select the target data as data to be used for training the machine learning model, based on the similarity between the individual feature for each target data and the individual feature for the target data already selected for training the machine learning model. In the present embodiment, when the similarity between the individual feature for each target data and the individual feature for the target data already selected for training the machine learning model is equal to or less than the reference value, the selection unit 35 selects the target data as data to be used for training the machine learning model. The target data already selected for the training of the machine learning model may include data already used for the training of the machine learning model. Therefore, the selection unit 35 may select the target data as the data used for the training of the machine learning model when the similarity between the individual feature for each target data and the individual feature for the data already used for the training of the machine learning model is equal to or less than the reference value.

In particular, in the present embodiment, the selection unit 35 determines the degree of similarity between the individual features based on the distance between the individual feature vectors. Therefore, the selection unit 35 determines that the similarity is high when the distance between the individual feature vectors is short, and determines that the similarity is low when the distance between the individual feature vectors is long. As the distance between the individual feature vectors, any distance such as Euclidean distance and Manhattan distance is used.

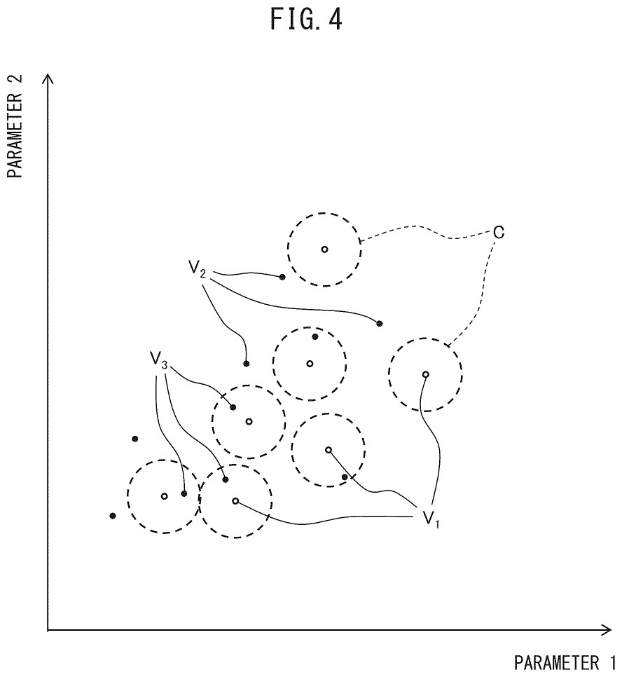

FIG. 4 is a diagram schematically illustrating a vector space of individual feature vectors. Although the individual feature vector is a multi-dimensional vector, the individual feature vector is conceptually represented in a two-dimensional vector space as a two-dimensional vector in FIG. 4. V₁ of the white circles in FIG. 4 represents individual feature vectors of target data that have been selected for training the machine learning model. A circle C indicated by a broken line in FIG. 4 indicates a range in which the distance from the individual feature vector of each of the already selected target data is a predetermined reference distance.

Here, in the present embodiment, when the distance between the individual feature vector of arbitrary target data and the individual feature vector of the already selected target data is equal to or larger than the predetermined reference distance, the selection unit 35 newly selects the target data as data to be used for training the machine learning model. Therefore, when the individual feature vector of arbitrary target data is located outside all the circles C in FIG. 4, that is, when the individual feature vector is a vector represented by V₂ in FIG. 4, the target data is newly selected as data to be used for training the machine learning model. On the other hand, when the individual feature vector of arbitrary target data is located in any circle C in FIG. 4, that is, when the individual feature vector is a vector represented by V₃ in FIG. 4, the target data is not selected as data to be used for training the machine learning model.

As a result, according to the present embodiment, data having a property different from that of the already selected target data is newly selected as data used for training the machine learning model. Therefore, various data having different properties can be selected as a training target. As a result, appropriate training of the machine learning model can be performed using data having different properties. In addition, the number of training targets is suppressed from being unnecessarily increased, and thus the processing time in the training of the machine learning model is suppressed from becoming unnecessarily long, and the data to be annotated is suppressed from being unnecessarily increased.

Further, in the present embodiment, the similarity is determined by considering not only the feature obtained from the target data (image data) but also the feature related to the situation in which the target data is obtained. For this reason, for example, in a case where the image data is similar but the situation in which the image data is obtained is different, the image data is selected as the data used for training the machine learning model. As a result, the data can be selected based on not only the similarity of the image itself but also the similarity of the situation in which the image is obtained, and therefore the machine learning model can be trained more appropriately.

The selection unit 35 may determine whether or not to select the target data as data to be used for training the machine learning model, based on the similarity between the individual feature for each target data and the individual feature for another target data in the data set. In particular, when the similarity between the individual feature for each target data and the individual feature for another target data in the data set is equal to or less than the reference value, the selection unit 35 selects the target data as data to be used for training the machine learning model. In this instance, the selection unit 35 may use any search technique, such as, for example, Approximate Nearest Neighbor Search.

The annotation unit 36 causes the user to annotate the image data selected by the selection unit 35. For example, when the machine learning model is a model that outputs the type of the object included in the image represented by the image data when the image data is input, the annotation unit 36 causes an output device such as a display to display the image and causes the user to input the type of the object in the image via the input device. The annotation unit 36 collectively stores the image data and the input ground truth data in the storage unit 20 as training data.

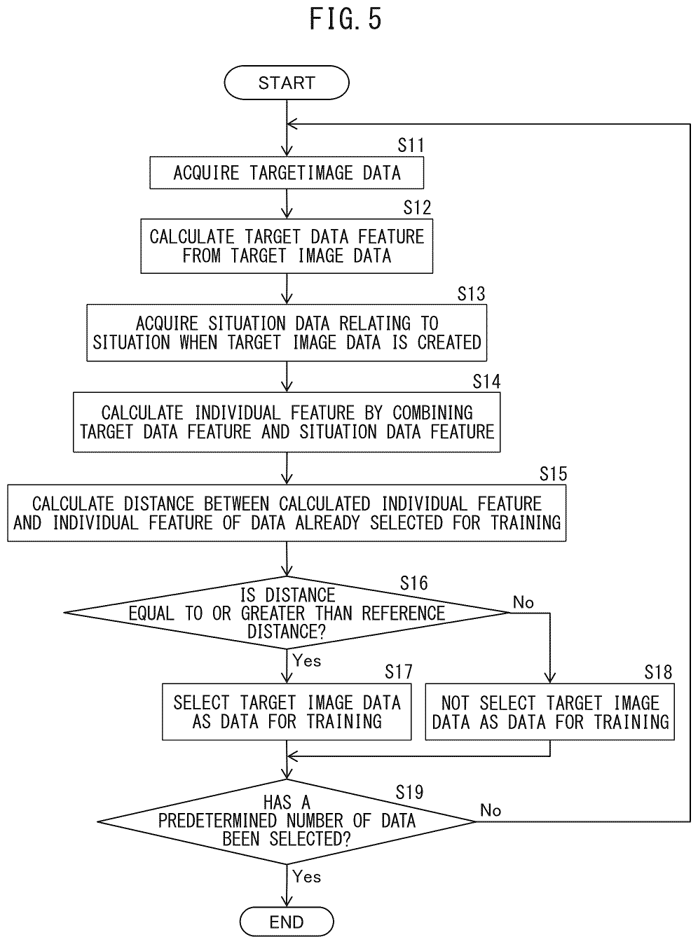

FIG. 5 is a flowchart illustrating a flow of a data selection process executed in the data selection device 1 according to one embodiment. The data selection process illustrated in FIG. 5 is executed in the processor 30.

As illustrated in FIG. 5, when the data selection process is started, first, the target data acquisition unit 31 acquires one piece of image data which can be selected as data used for training the machine learning model, from the storage unit 20 (step S11). Next, the feature calculation unit 33 calculates the target data feature from the image data acquired by the target data acquisition unit 31 using the feature calculation model for the target data (step S12).

Next, the situation data acquisition unit 32 acquires, from the storage unit 20, situation data related to the situation when the image data acquired by the target data acquisition unit 31 is generated (step S13). At this time, the feature calculation unit 33 may calculate the situation data feature using the feature calculation model for the situation data from the situation data acquired by the situation data acquisition unit.

Next, the individual feature calculation unit 34 calculates the individual feature by combining the target data feature calculated in step S12 and the situation data feature calculated based on the situation data acquired in step S13 (step S14).

Next, the selection unit 35 calculates the distance between the individual feature vectors calculated in step S14 and the individual feature vectors for the image data already selected for training the machine learning model (that is, the similarity between the individual features) (step S15). When a plurality of pieces of image data have already been selected for training the machine learning model, the selection unit 35 calculates a distance from the individual feature vectors of all the pieces of image data that have already been selected.

Next, the selection unit 35 determines whether or not the shortest distance among the distances calculated in step S15 is equal to or greater than the reference distance (whether or not the similarity is equal to or less than the reference value) (step S16). When it is determined that the distance between the individual feature vectors is equal to or greater than the reference distance in step S16, the selection unit 35 selects the image data acquired in step S11 as the training image data (step S17). The selection unit 35 selects the image data acquired in step S11 as the image data for training, when there is no image data already selected for training the machine learning model.

On the other hand, when it is determined in step S16 that the distance between the individual feature vectors is less than the reference distance, the selection unit 35 does not select the image data acquired in step S11 as the training image data (step S18).

When the selection of the image data is determined in step S17 or S18, the selection unit 35 determines whether or not a predetermined number of image data has been selected (step S19). The predetermined number is, for example, a number necessary for sufficiently training the machine learning model. When it is determined in step S19 that a predetermined number of images have not been selected, steps S12 to S18 are repeated. On the other hand, when it is determined that a predetermined number of pieces of image data have been selected in step S19, the data selection process is ended. The selection unit 35 may also end the data selection process when the determination of whether or not to select the image data for all the image data included in the data set is completed.

While embodiments according to the present disclosure have been described above, the present disclosure is not limited to these embodiments, and various modifications and changes can be made within the scope of the claims.

1. A data selection device which selects data used for training a machine learning model from a dataset including a plurality of target data, comprising a processor,
the processor is configured to:
calculate, from one target data in the dataset, a target data feature of the target data using a feature calculation model; and
determine whether to select the target data as data used for training the machine learning model, based on similarity between an individual feature relating to the target data including the target data feature, and an individual feature of other target data in the dataset or an individual feature of data already selected for training the machine learning model.

2. The data selection device according to claim 1, wherein the processor is configured to:
acquire situation data relating to a situation when each target data was generated; and
calculate an individual feature by combining the calculated target data feature with a feature of the acquired situation data, for each target data.

3. The data selection device according to claim 1, wherein the processor is configured to select one target data as data used for training the machine learning model when a similarity between an individual feature of data already selected for training the machine learning model and an individual feature of the target data is equal to or less than a predetermined value.

4. The data selection device according to claim 1, wherein the processor is configured to select one target data as data used for training the machine learning model when a similarity between an individual feature of data already used for training the machine learning model and an individual feature of the target data is equal to or less than a predetermined value.

5. A non-transitory computer readable medium having recorded thereon a data selection program which selects the data used for training a machine learning model from a dataset including a plurality of target data, the data selection program causing a computer to execute a process comprising:
calculating, from one target data in the dataset, a target data feature of the target data using a feature calculation model; and
determining whether to select the target data as data used for training the machine learning model, based on similarity between an individual feature relating to the target data including the target data feature, and an individual feature of other target data in the dataset or an individual feature of data already selected as training of the machine learning model.
